(19) United States
(12) Patent Application Publication
(10) Pub. No.: US 2010/0289702 A1
(43) Pub. Date: Nov. 18, 2010

(54) DUAL-BAND ANTENNA AND PORTABLE WIRELESS COMMUNICATION DEVICE USING THE SAME

(75) Inventors: HSIN-HUNG LIU, Tu-Cheng (TW); TSUNG-LIN HSIEH, Tu-Cheng (TW); WEN-HSIU HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/493,342

(22) Filed: Jun. 29, 2009

(30) Foreign Application Priority Data
May 15, 2009 (CN) 200910302370.X

(51) Int. Cl. H01Q 1/36; H01Q 5/00

(52) U.S. Cl. 343/700 MS; 343/860

(57) ABSTRACT

A dual-band antenna used in a portable wireless communication device includes a main antenna body, a feed end, and a grounding end. The feed end and the grounding end are positioned on the main antenna body. The main antenna body includes a matching portion for adjusting the match impendence of the dual-band antenna, a first antenna portion a for transmitting/receiving wireless signals in high frequency bands, and a second antenna portion for transmitting/receiving wireless signals in low frequency bands. The first antenna and the second antenna are connected to two opposition end of the matching portion. The matching portion, the first antenna, and the second antenna are coplanar.

### BACKGROUND

1. Technical Field

The disclosure generally relates to antennas, particularly to a dual-band antenna and a portable wireless communication device using the dual-band antenna.

2. Description of Related Art

Antennas are important components of portable wireless communication devices such as mobile phones and personal digital assistants (PDAs) used for transmitting/receiving signals. Portable wireless communication devices usually need a dual-band or multi-band antenna to communicate at different frequency bands.

Referring to FIG. 1, a conventional dual-antenna 80 includes a first radiating arm 82 and second radiating arm 84. The first radiating arm 82 and the second radiating arm 84 are strip. Only when the lengths of the first radiating arm 82 and the second radiating arm 84 are chosen to equal ¼ of the wavelength of signal they need to send, can they transmit/receive signals of that frequency band. So the conventional dual-antenna 80 occupies considerable space when installed in a portable wireless communication device, and the portable wireless communication devices having the dual-band antenna 80 are difficult to miniaturize.

Therefore, there is room for improvement within the art.

### BRIEF DESCRIPTION OF THE DRAWINGS

Many aspects of the dual-band antenna and portable wireless communication device can be better understood with reference to the following drawings. The components in the drawings are not necessarily drawn to scale, the emphasis instead being placed upon clearly illustrating the principles of the dual-band antenna and the portable wireless communication device.

FIG. 1 shows a schematic view of a conventional dual-band antenna.

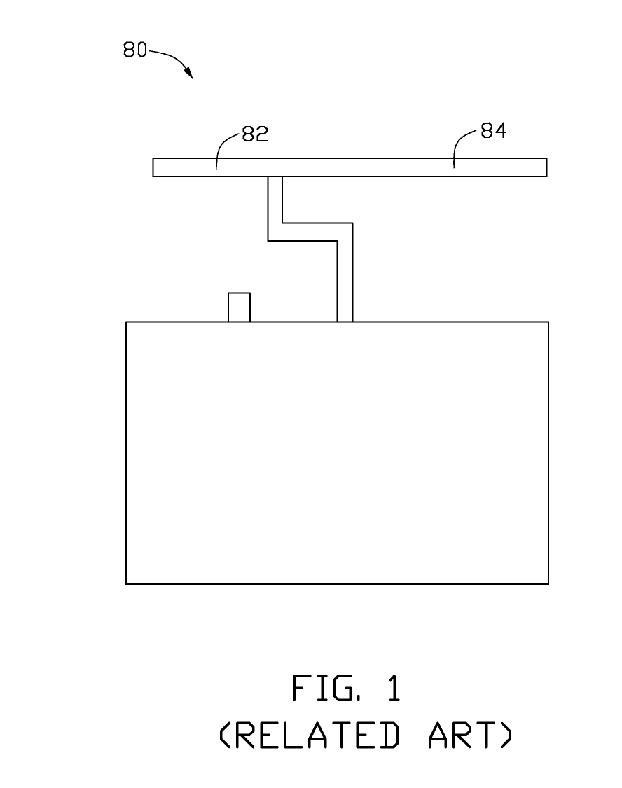

FIG. 2 shows a schematic view of a dual-band antenna, according to an exemplary embodiment.

FIG. 3 shows a schematic view of the dual-band antenna of FIG. 2 mounted on a mobile phone.

FIG. 4 shows an exemplary test graph obtained from the dual-band antenna of FIG. 2, disclosing return loss varying with frequency.

### DETAILED DESCRIPTION

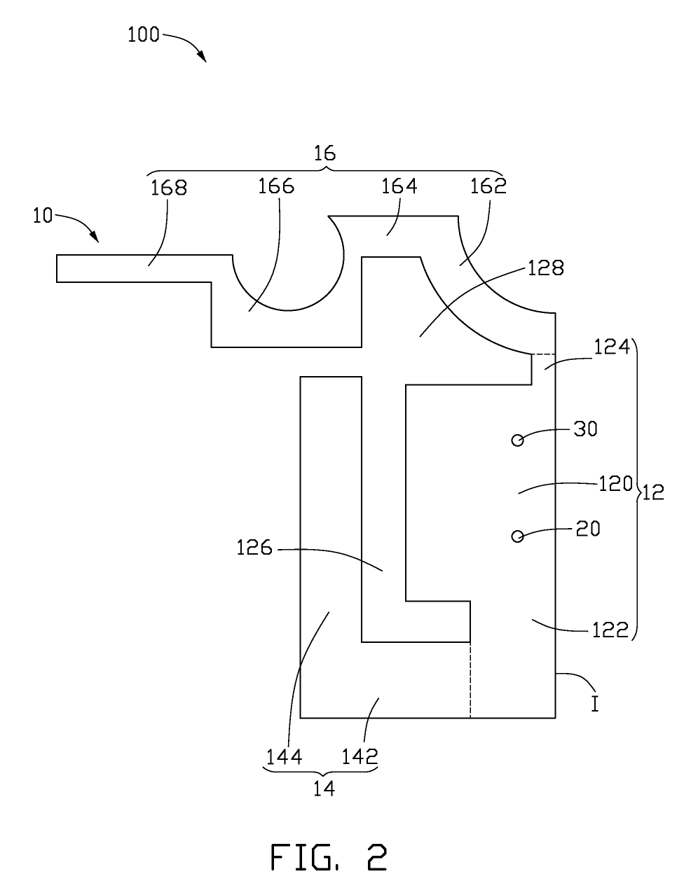

Referring to FIG. 2, a dual-band antenna 100 used in a portable wireless communication device of the exemplary embodiment is a planar inverted-F antenna (PIFA) including a main antenna body 10, a grounding end 20, and a feed end 30. The grounding end 20 and the feed end 30 are positioned on the main antenna body 10.

The main antenna body 10 is a flexible printed circuit board (FPCB) including a matching portion 12, a first antenna portion 14 for transmitting/receiving wireless signals at high frequencies and a second antenna portion 16 for transmitting/receiving wireless signals at low frequencies. One end of the matching portion 12 is connected to the first antenna portion 14, and another end of the matching portion 12 is connected to the second antenna portion 16. The matching portion 12, the first antenna portion 14, and the second antenna portion 16 are coplanar, and form the main antenna body 10.

The matching portion 12 includes a main body 120, a first connecting end 122 and a second connecting end 124. The main body 120 is a rectangular sheet. The first connecting end 122 and the second connecting end 124 separately extend from two opposite ends of the main body 120 along one peripheral edge of the main body 120. The width of the first connecting 122 is approximately half of that of the main body 120. The second connecting end 124 is narrower than the main body 120 and the first connecting end 124. In fabrication, the matching impedance of the dual-band antenna 100 can be adjusted by changing the dimension of the matching portion 12.

The first antenna portion 14 is an L-shaped sheet including a first band section 142 and a second longer band section 144 perpendicularly connected to the first band section 142. The first band section 142 and the second band section 144 are both rectangular. The first antenna portion 14 is set at one side of the matching portion 12 opposite to the first connecting end 122 and the second connecting end 124. One end of the first band section 142 opposite to the second band section 144 is perpendicularly connected to the first connecting end 122 along the edge of the first connecting end 122. The second band section 144 is parallel to the main portion 120. An L-shaped slot 126 is formed between the matching portion 12 and first antenna portion 14.

The second antenna portion 16 includes a first extending portion 162, a second extending portion 164, a third extending portion 166, and a fourth extending portion 168 all connected in series. The shape and dimension of the second antenna portion 16 can be adjusted according to the layout of the internal components of the portable wireless communication device the antenna 100 is to be mounted in. In an exemplary embodiment, the first extending portion 162 is an arcuate sheet and approximately ¼ portion of a circle. One end of the first extending portion 162 is connected to the second connecting end 124 along a direction perpendicular to its tangent. Another end of the first extending portion 162 is connected to the second extending portion 164 along a direction perpendicular to its tangent.

The second extending portion 164 is an approximately strip-shaped sheet. One end of the second extending portion 164 extends from the end of the first extending portion 162 along a direction perpendicular to its tangent, and another end of the second extending portion 164 is connected to the third extending portion 166. The second extending portion 164 is parallel to one edge of the main body 120.

The third extending portion 166 is made from a square sheet with an arcuate gap (not labeled) set therein. One end of the third extending portion 166 is connected to the second extending portion 164, and another shorter end of the third extending portion 166 is connected to the fourth extending portion 168. The fourth extending portion 168 is a strip-shaped sheet extending from the end of the third extending portion 166. A gap 128 is formed between the second antenna portion 16 and the matching portion 12. The gap 128 communicates with the slot 126.

The feed end 20 and the grounding end 30 are electronic connection points positioned on one side of the main body 120 adjacent to the first connecting end 122 and the second connecting end 124. The feed end 20 is configured for feeding in signals. The grounding end 30 is configured for offering a ground plane for the dual-band antenna 100.

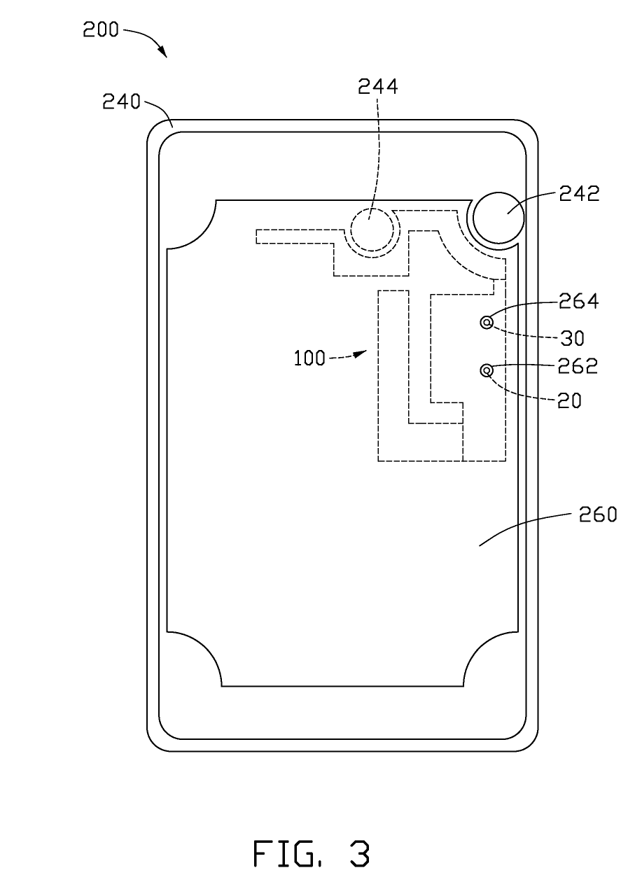

Referring to FIG. 3, a mobile phone 200 incorporating the dual-band antenna 100 (shown in FIG. 2) is shown. The mobile phone 200 includes a housing 240 and a main board 260 positioned on the housing 240. The housing 240 includes a positioning pole 242 adjacent to one side thereof for positioning another shell of the mobile phone 200 such as a battery cover. The housing 240 defines a hole 244 for receiving other electronic elements of the mobile phone 200 such as a camera. A feed point 262 and a grounding point 264 are disposed on the main board 260 corresponding to the feed end 20 and the grounding end 30. The dual-band antenna 100 is set on the inner surface of the housing 240. The first extending portion 162 and the third extending portion 164 are disposed along the periphery edge of the positioning pole 242 and the hole 244, the feed end 20 and the grounding end 30 are separately connected to the feed point 262 and the grounding point 264 of the main board 260. Thus, the exemplary configuration of the antenna 100 described above, allows the antenna 100 to be positioned between existing internal components (e.g. positioning pole 242 and hole 244) of the portable wireless communication device. If such internal components are omitted or positioned differently from the example, the shape of the second antenna portion 16 can be adjusted accordingly, while retaining the length of the second circuit path being equal to ¼ of the wavelength of the signal need to be sent.

In use, the dual-band antenna 100 receives the signals from the feed point 262 via the feed end 20, and forms a first circuit path and a second circuit path having different electrical lengths. The first circuit path is from the feed end 20 to the first antenna portion 14 through the first connecting end 122. The second circuit path is from the feed end 20 to the second antenna portion 16 through the second connecting end 124. As is well known, signals at different frequencies have different wavelengths correspondingly. When the electrical lengths of the first circuit path and the second circuit path are equal to ¼ of the wavelength of a signal, the corresponding first antenna portion 14 or the second antenna 16 portion can transmit the signal.

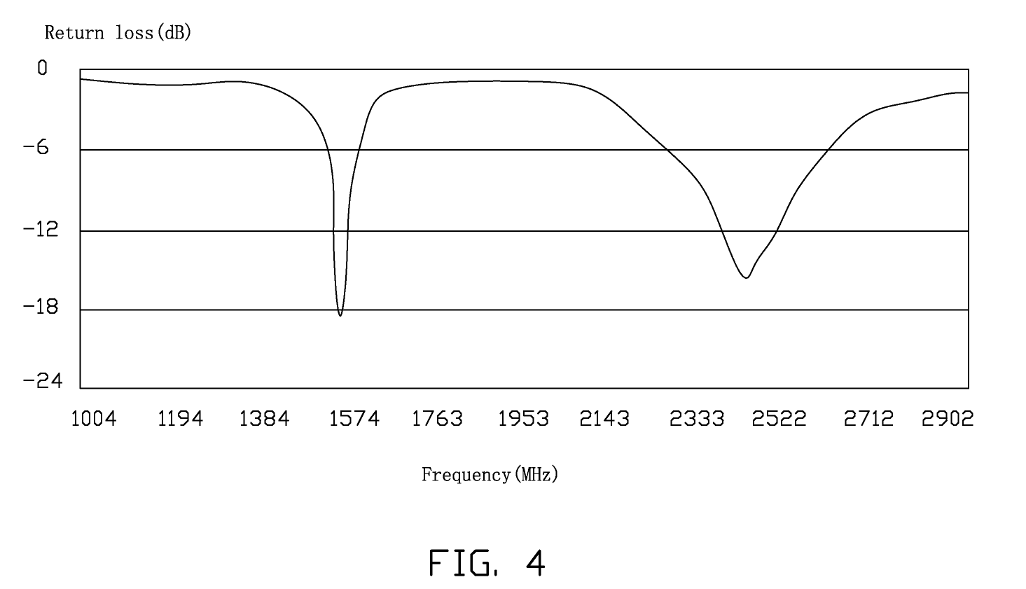

Referring to FIG. 4, In this exemplary embodiment, the length of the first circuit path is approximately 32 mm, and the first antenna portion 14 generates a first resonance frequency of 2.45 GHz belonging to frequency band of 2.40 GHz˜2.48 GHz suitable for operating in a Bluetooth communication system. The length of the second circuit path is approximately 48 mm, and the second antenna portion 16 generates a second resonance frequency of 1.57 GHz belonging to frequency band of 1.575 GHz˜1.580 GHz suitable for operating in a GPS (Global Position System) communication system.

The structure of the dual-band antenna 100 is planar, and does not occupy much space within portable wireless communication devices, which is advantageous to miniaturization of mobile phones. Furthermore, the dual-band antenna 100 provides two resonance frequencies via the first antenna portion 14 and the second antenna portion 16 suitable for both Bluetooth and GPS communication systems, which reduces the cost of portable wireless communication device working for different communication systems.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A dual-band antenna used in a portable wireless communication device, comprising:
a main antenna body comprising:
a matching portion for adjusting the match impendence of the dual-band antenna;
a first antenna portion for transmitting/receiving wireless signals in high frequency bands; and
a second antenna portion for transmitting/receiving wireless signals in low frequency bands; wherein the first antenna portion and the second antenna portion are connected to two opposite end of the matching portion, and the matching portion, the first antenna portion, and the second antenna portion are coplanar; a feed end; and
a grounding end; the feed end and the grounding end positioned on the main antenna body.

2. The dual-band antenna as claimed in claim 1, wherein the matching portion includes a main body, a first connecting end and a second connecting end extending from two opposite ends of the main body separately along one peripheral edge thereof, ends of the first connecting end and the second connecting end opposite to the main body are connected to the first antenna portion and the second antenna portion separately.

3. The dual-band antenna as claimed in claim 2, wherein the first antenna portion is an L-shaped sheet including a first band section and a second longer band section connected to the first band section perpendicularly.

4. The dual-band antenna as claimed in claim 3, wherein one end of the first band section opposite to the second band section is perpendicularly connected to the first connecting portion along the edge thereof, the second band section is parallel to the first connecting portion, a slot is formed between the matching portion and first antenna portion.

5. The dual-band antenna as claimed in claim 1, wherein the second antenna portion includes a first extending portion, a second extending portion, a third extending portion and a fourth extending portion connected in series, the first extending portion is connected to the matching portion, and a gap is formed between the matching portion and the second antenna portion.

6. The dual-band antenna as claimed in claim 4, wherein the first extending portion is an arcuate sheet and approximately ¼ portion of a circle, one end of the first extending portion is connected to the matching portion along a direction perpendicular to its tangent, another end of the first extending portion is connected to the second extending portion along a direction perpendicular to its tangent.

7. The dual-band antenna as claimed in claim 4, wherein the second extending portion is a strip-shaped sheet, one end of the second extending portion is extended from the first extending portion, another end of the second extending portion is connected to the third extending portion.

8. The dual-band antenna as claimed in claim 4, wherein the third extending portion is made from a square sheet with an arcuate gap set on it, one end of the third extending portion is connected to the second extending portion, and another shorter end of the third extending portion is connected to the fourth extending portion.

9. The dual-band antenna as claimed in claim 4, wherein the fourth extending portion is a strip-shaped sheet extending from the end of the third extending portion.

10. A portable wireless communication device, comprising:
a main board comprising:
a feed point and a grounding point are disposed thereon; and
an dual-band antenna comprising:
a main antenna body comprising:
a matching portion for adjusting the match impendence of the dual-band antenna;
a first antenna portion for transmitting/receiving wireless signals in high frequency bands; and
a second antenna portion for transmitting/receiving wireless signals in low frequency bands; wherein the first antenna portion and the second antenna portion are connected to two opposite end of the matching portion, and the matching portion, the first antenna portion, and the second antenna portion are coplanar;
a feed end; and
a grounding end; the feed end and the grounding end positioned on the main antenna body, and connected to the a feed point and a grounding point correspondingly.

11. The portable wireless communication device as claimed in claim 10, wherein the matching portion includes a main body, a first connecting end and a second connecting end extending from two opposite ends of the main body separately along one peripheral edge thereof, ends of the first connecting end and the second connecting end opposite to the main body are connected to the first antenna portion and the second antenna portion separately.

12. The portable wireless communication device as claimed in claim 11, wherein the first antenna portion is an L-shaped sheet including a first band section and a second longer band section connected to the first band section perpendicularly.

13. The portable wireless communication device as claimed in claim 12, wherein one end of the first band section opposite to the second band section is perpendicularly connected to the first connecting portion along the edge thereof, the second band section is parallel to the first connecting portion, a slot is formed between the matching portion and first antenna portion.

14. The portable wireless communication device as claimed in claim 10, wherein the second antenna portion includes a first extending portion, a second extending portion, a third extending portion and a fourth extending portion connected in series, the first extending portion is connected to the matching portion, and a gap is formed between the matching portion and the second antenna portion.

15. The portable wireless communication device as claimed in claim 14, wherein the first extending portion is an arcuate sheet and approximately ¼ portion of a circle, one end of the first extending portion is connected to the matching portion along a direction perpendicular to its tangent, another end of the first extending portion is connected to the second extending portion along a direction perpendicular to its tangent.

16. The portable wireless communication device as claimed in claim 14, wherein the second extending portion is a strip-shaped sheet, one end of the second extending portion is extended from the first extending portion, another end of the second extending portion is connected to the third extending portion.

17. The portable wireless communication device as claimed in claim 14, wherein the third extending portion is made from a square sheet with an arcuate gap set on it, one end of the third extending portion is connected to the second extending portion, and another shorter end of the third extending portion is connected to the fourth extending portion.

18. The portable wireless communication device as claimed in claim 14, wherein the fourth extending portion is a strip-shaped sheet extending from the end of the third extending portion.
